(19) United States
(12) Patent Application Publication
(10) Pub. No.: US 2016/0111001 A1
(43) Pub. Date: Apr. 21, 2016

(54) SYSTEM AND METHOD FOR REMOTELY CONTROLLING OPERATIONS OF VEHICLE

(71) Applicant: HON HAI PRECISION INDUSTRY CO., LTD., New Taipei (TW)

(72) Inventors: Mao-Yu LIN, New Taipei (TW); Wei-An CHEN, New Taipei (TW)

(21) Appl. No.: 14/516,179

(22) Filed: Oct. 16, 2014

(51) Int. Cl. G08G 1/127; G07C 9/00

(52) U.S. Cl. CPC G08G 1/127; G07C 9/00007; G07C 2009/00769

(57) ABSTRACT

A system for remotely controlling operation of a vehicle comprises a handheld electronic device, a key, and a base station mounted in the vehicle. The handheld electronic device is bi-directionally and wirelessly communicable with the key, while the key is bi-directionally and wirelessly communicable with the base station. An instruction which can be a vehicle searching instruction is sent to the base station from the handheld electronic device via the key. The base station sends position information of the vehicle to the handheld electronic device via the key upon receiving the instruction for searching the vehicle.

### FIELD

The present disclosure relates to automobile technology, and particularly, to a system and method for remotely controlling operations of vehicle which include identifying location of a car whereby a driver can more easily find his or her car when he or she forgets where the car is parked.

### BACKGROUND

Following the advancement of automobile technology, a plurality of remote control technologies for a vehicle have been developed, such as RKE (remote keyless entry) system and PKE (passive keyless entry) system, which use RF (radio frequency) technology to control operations of the vehicle. The RKE and PKE systems provide vehicle searching functions; however such searching functions cannot be visualized to enable the driver to easily know the direction along which he or she needs to move to get his or her car.

Since the use of mobile communication devices, such as mobile phones, particularly, smart phones, becomes more and more popular, some ideas have been proposed by persons skilled in the computer technology to incorporate vehicle searching function and other control functions into the mobile communication device, whereby a display screen of the mobile communication device can be used to show the position of the car to facilitate the driver to more easily find his or her car. However due to safety consideration, such proposals are not deemed as practical solutions by person skilled in automobile technology, since interferences between the mobile communication device and electronic devices of the vehicle may occur during use of the mobile communication device in application other than vehicle search and control.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic view showing a system for remotely controlling operations of a vehicle in accordance with the present disclosure.

FIG. 2 is a block diagram showing constituting modules of a mobile communication device for the vehicle remote control system of FIG. 1.

FIG. 3 is a block diagram showing constituting modules of a chip key for the vehicle remote control system of FIG. 1.

FIG. 4 is a block diagram showing constituting modules of a base station in a vehicle for the vehicle remote control system of FIG. 1.

FIGS. 5-6 are a flow chart showing a method for remotely controlling operations of a vehicle by using the vehicle remote control system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising,” when utilized, means “including, but not necessarily limited to”; it specifically indicates open-ended inclusion or membership in the so-described combination, group, series and the like.

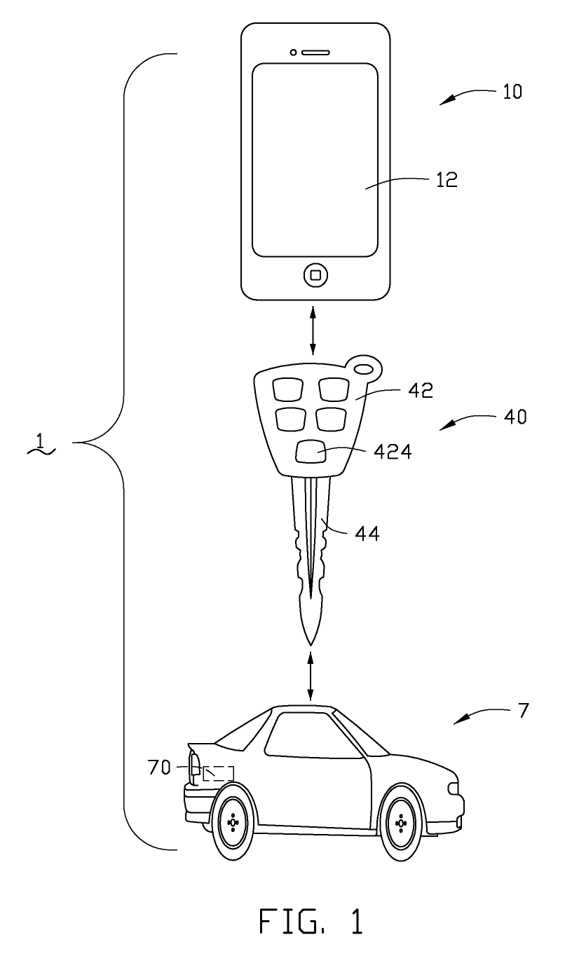

Referring to FIG. 1, a system 1 for remotely controlling operations of a vehicle includes a handheld electronic device 10, a chip key 40 and a base station 70 mounted in a vehicle 7. The handheld electronic device 10 has a wireless communication capability, which can send/receive voice/text information to/from other devices in a wireless manner, wherein the handheld electronic device 10 can be a mobile phone such as a smart phone, or a tablet computer. The handheld electronic device 10 has a display screen 12, which can be a touch screen. The chip key 40 can have a body 42 and a substantially elongated and flat key portion 44 extending downwardly from the body 42. In the present disclosure, the key portion 44 is optional. If the vehicle 7 has a keyless start, the key portion 44 is not necessary. The body 42 can have chips (not shown) therein. The chips can be programmed with an RKE (remote keyless entry) system or a PKE (passive keyless entry) system. On a front face of the body 42, a plurality of buttons 424 can be provided for controlling operations of the vehicle 7 via the base station 70, which include but not limited to, lock and unlock of the doors of the vehicle 7 and alarm. The base station 70 is mounted in the vehicle 7 at a convenient position. According to the disclosed embodiment, the base station 70 is mounted in the trunk of the vehicle 7 which is a car. The base station 70 can have a substantially cuboidal enclosure with electronic components (not shown) mounted therein. The handheld electronic device 10 can bi-directionally communicate with the chip key 40 in a wireless manner, while the chip key 40 can bi-directionally communicate with the base station 70 in the vehicle 7 in a wireless manner. Nevertheless, the handheld electronic device 10 cannot directly communicate with the base station 70 in the vehicle 7.

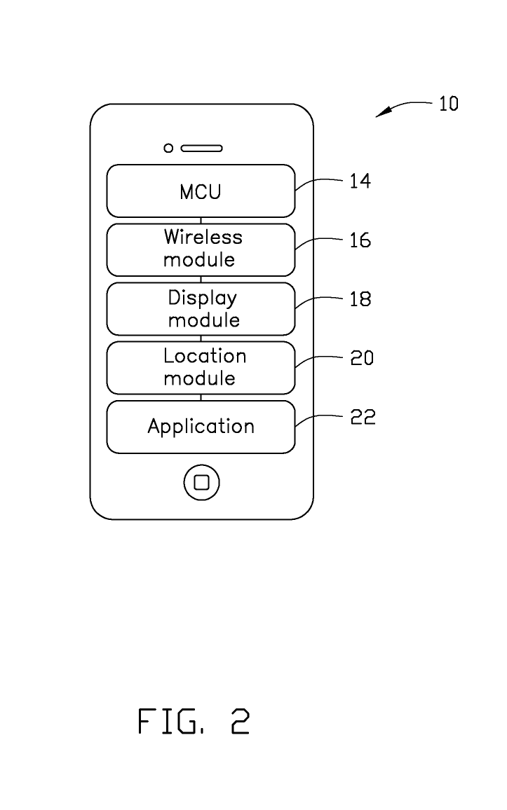

Referring to FIG. 2, the handheld electronic device 10 can have an MCU (micro processor unit) 14 for controlling operations of the handle electronic device 10 and wireless communication of the handheld electronic device 10 with the chip key 40. The MCU 14 can be a micro processor unit of the handheld electronic device 10 for controlling other operations thereof, such as sending/receiving voice/text information to/from other handheld electronic devices, internet browsing or photographing. A wireless module 16 is provided for sending/receiving wireless signals to/from the chip key 40. The wireless module 16 can communicate with the chip key 40 via wifi wireless communication protocol or Bluetooth wireless communication protocol. A display module 18 is provided for showing information regarding the remote control of the vehicle 7 on the display screen 12. In a vehicle searching mode, the display module 18 displays related position information of the vehicle 7 on the display screen 12 of the handheld electronic device 10, when the position of the vehicle 7 is determined. The displaying module 18 can show both positions of the driver carrying the chip key 40 and the handheld electronic device 10 and the vehicle 7 on the display screen 12 whereby the driver can easily recognize the position of the vehicle 7 related to the driver so that the driver can easily find the vehicle 7. In addition to showing the position of the vehicle, the display module 18 can also show button icons (not shown) for controlling operations of the vehicle 7 on the display screen 12 in a vehicle operation control mode, whereby the driver can remotely control operations of the vehicle 7 by manipulating these icons, which include, but not limited to, lock and unlock of doors of the vehicle 7 and alarm. The control commands are sent to the base station 70 from the handheld electronic device 10 via the chip key 40.

A location module 20 is provided for determining the location of the driver which can be achieved by G-sensor, GPS and/or gyroscope in the handheld electronic device 10, and the location of the vehicle 7 which can be performed by analyzing RSSI (received signal strength indication) or GPS (global positioning system) information from the base station 70 in the vehicle 7 via the chip key 40. An application 22 provided by the manufacturer of the vehicle 7 is downloaded to the handheld electronic device 10. The application 22 includes programs which when executed enable the MCU 14, the wireless module 16, the display module 18 and the location module 20 to function for identifying the position of the vehicle 7, and controlling operations of the vehicle 7.

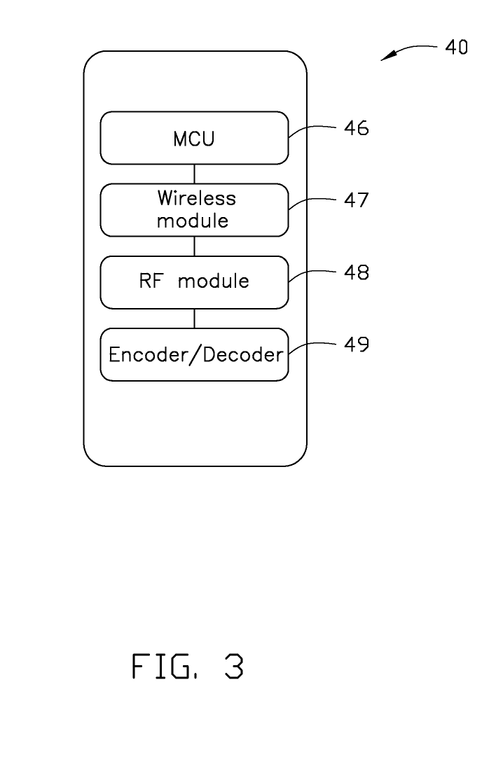

Referring to FIG. 3, the chip key 40 can include an MCU 46 for controlling operations of the chip key 40 and wireless communications between the chip key 40 and the handheld electronic device 10 and between the chip key 40 and the base station 70. A wireless module 47 is provided for wireless communication with the handheld electronic device 10 by wifi or Bluetooth wireless communication protocol. An RF (radio frequency) module 48 is provided for wireless communication with the base station 70 by radio frequency (RF) signals. An encoder/decoder 49 is provided for encoding signals sent from the chip key 40 to the base station 70 and decoding signals sent from the base station 70 to the chip key 40 whereby only when the chip key 40 and the vehicle 7 are a credential pair, commands/instructions/information can flow bi-directionally between the chip key 40 and the base station 70. The encoding/decoding of the encoder/decoder 49 is performed in accordance with Advanced Encryption Standard 128 (AES-128).

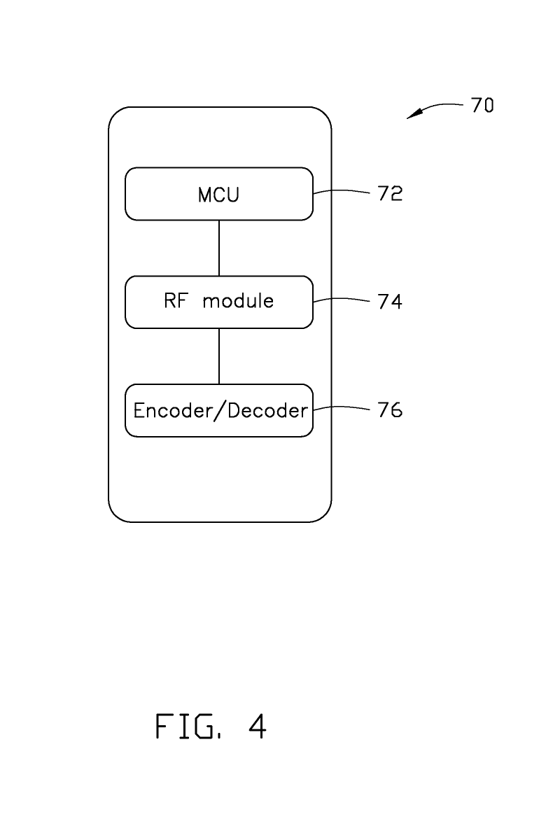

Referring to FIG. 4, the base station 70 includes an MCU 72 for controlling operations of the base station 70 and communication with the chip key 40. An RF module 74 is provided for communicating with the chip key 40 by RF signals. An encoder/decoder 76 is provided for encoding signals sent from the base station 70 to the chip key 40 and decoding signals sent from the chip key 40 to the base station 70. Only when the chip key 40 and the vehicle 7 are a credential pair, commands/instructions/information can flow bi-directionally between the chip key 40 and the base station 70. The encoding/decoding of the encoder/decoder 76 is performed in accordance with Advanced Encryption Standard 128 (AES-128).

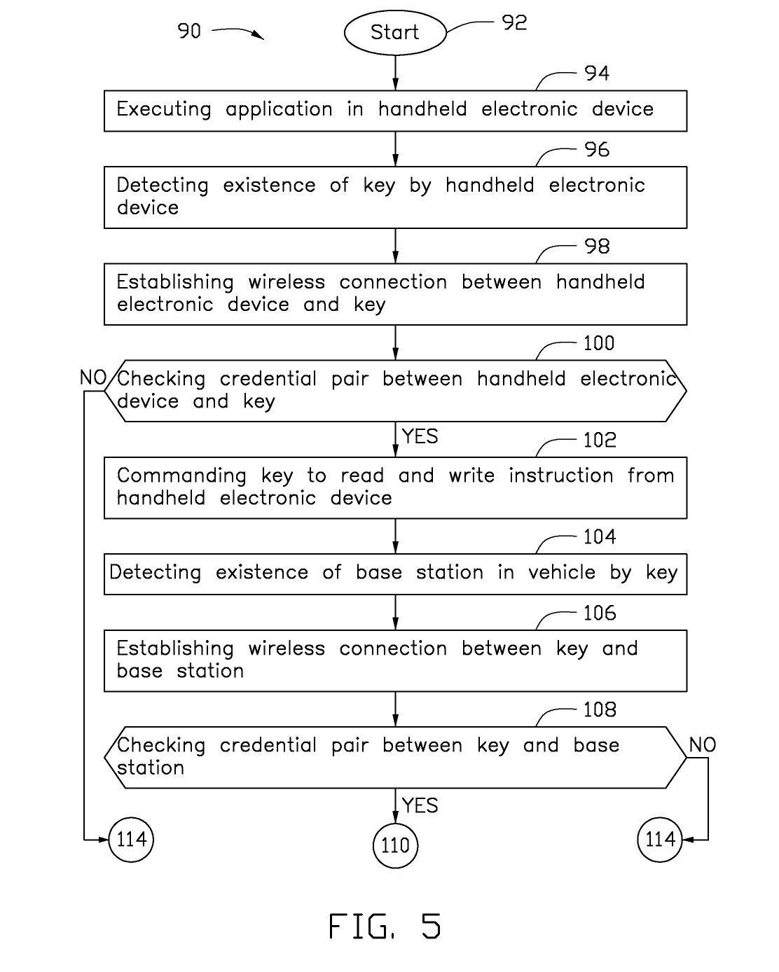

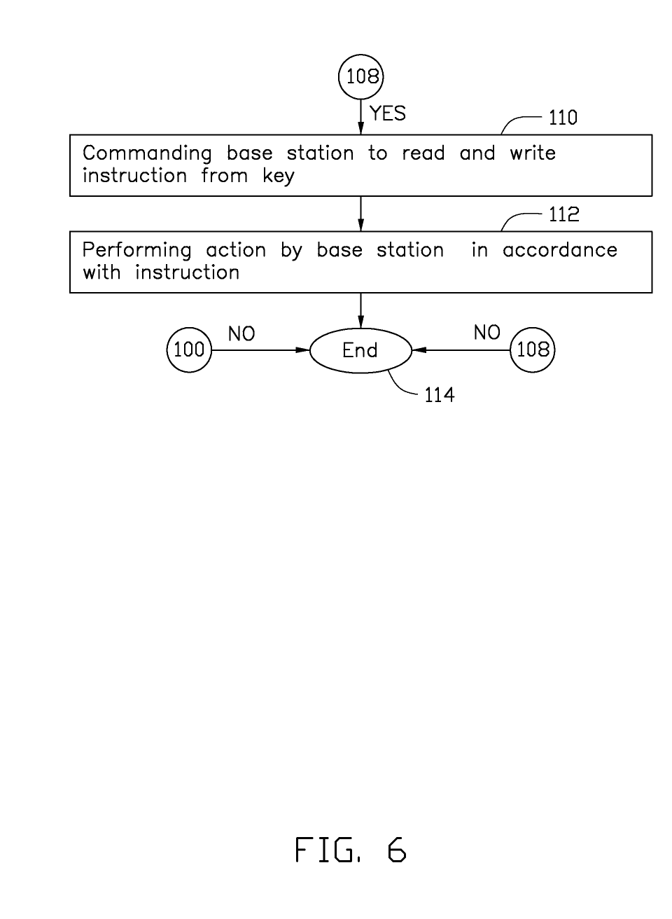

Referring to FIGS. 5-6, a method 90 for remotely controlling operations of the vehicle 7 is disclosed which starts from block 92. In block 94, the driver operates the handheld electronic device 10 to execute the application 22. In block 96, the handheld electronic device 10 detects an existence of the chip key 40 by the wireless module 16 thereof. In block 98, the handheld electronic device 10 establishes a wireless connection between the handheld electronic device 10 and the chip key 40 by the wireless modules 16, 47 thereof. In block 100, the handheld electronic device 10 performs a check of credential pairing with the chip key 40 by the wireless modules 16, 47 thereof. Should the result of the check be that the handheld electronic device 10 and the chip key 40 are a credential pair, the method 90 flows to block 102. Should the result of the check be that the handheld electronic device 10 and the chip key 40 are not a credential pair, the method 90 flows to block 114 in which the method 90 is ended. In block 102, the handheld electronic device 10 sends commands to the chip key 40 to have the chip key 40 read and write instructions from the handheld electronic device 10. The instructions in one embodiment are for searching the vehicle 70. In block 104 the chip key 40 detects an existence of the base station 70 (accordingly the vehicle 7) by the RF module 48 thereof. In block 106, the chip key 40 establishes a wireless connection between the chip key 40 and the base station 70 by the RF modules 48, 74 thereof. In block 108, the chip key 40 performs a check of credential pairing with the base station 70 (accordingly the vehicle 7) by the RF modules 48, 74 thereof. Should the result of the check be that the chip key 40 and the base station 70 (accordingly the vehicle 7) are a credential pair, the method 90 flows to block 110. Should the result of the check be that the chip key 40 and the base station 70 (accordingly the vehicle 7) are not a credential pair, the method 90 flows to block 114 in which the method 90 is ended. In block 110, the chip key 40 sends commands to the base station 70 to have the base station 70 read and write instructions from the chip key 40, which according to this embodiment are for searching the vehicle 7. In block 112, the base station 70 of the vehicle 7 sends information via RF signals to the chip key 40 to indicate a position of the vehicle 7, which is then sent to the handheld electronic device 10 from the chip key 40, whereby the handheld electronic device 10 can show the position of the vehicle 7 on the display screen 12. Thus, the driver can conveniently find the vehicle 7. In block 114, the method 90 is ended.

The above description is related to an operating mode for vehicle searching. Alternatively, in another operating mode (embodiment), the instructions sent from the handheld electronic device 10 to the chip key 40 in block 102 of the method 90 can be for controlling operations of the vehicle 7, which include, but not limited to, lock and unlock of doors of the vehicle 7 and alarm. And in block 112, the base station 70 have the vehicle 7 operate according to the instructions for locking or unlocking the doors or generating alarm sound.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A system for identifying a position of a vehicle on a handheld electronic device, comprising:
a vehicle key able to communicate in a bi-directional wireless manner with a handheld electronic device; and
a base station mountable in a vehicle, the base station able to communicate in a bi-directional wireless manner with the vehicle key;
wherein when the vehicle key receives search instructions from the handheld electronic device to search for the vehicle, the vehicle key sends the search instruction to the base station; and
wherein, when the base station receives the search instructions from the vehicle key, the base station sends a position signal to the vehicle key and the vehicle key forwards the position signal to the handheld electronic device allowing the handheld electronic device to display a position of the vehicle on a display screen of the handheld electronic device.

2. The system of claim 1, wherein the handheld electronic device comprises:
a micro processor unit for controlling operations of the handheld electronic device and communication of the handheld electronic device with the key;
a wireless module for wirelessly connecting the handheld electronic device with the key;
a displaying module for displaying the position of the vehicle on the display screen;
a location module for determining the position of the vehicle when the handheld electronic devices receives the position signal from the base station via the key; and
an application which when executed enables the handheld electronic device to send out the instruction for searching the vehicle.

3. The system of claim 2, wherein the vehicle key is a chip key programmed with one of RKE (remote keyless entry) system and PKE (passive keyless entry) system, and comprises a micro processor unit for controlling operation of the vehicle key and communication of the vehicle key with the handheld electronic device and the base station, a wireless module for wireless connection with the handheld electronic device, an RF (radio frequency) module for wireless connection with the base station, and an encoder/decoder for encoding signals from the vehicle key to the base station and for decoding signals from the base station to the vehicle key.

4. The system of claim 3, wherein the base station comprises a micro processor unit for controlling operation of the base station and communication of the base station with the vehicle key, an RF module for wireless connection with the vehicle key, and an encoder/decoder for encoding the signals from the base station to the vehicle key and decoding the signals from the vehicle key to the base station.

5. The system of claim 3, wherein the vehicle key includes a body having at least a button formed thereon and a key portion extending downwardly from the body.

6. The system of claim 3, wherein the handheld electronic device is a mobile phone.

7. The system of claim 6, wherein the mobile phone is a smart phone.

8. The system of claim 3, wherein the handheld electronic device is a tablet computer.

9. A method for searching a vehicle, the vehicle having a base station mounted therein, comprising:
executing an application in a handheld electronic device to start searching the vehicle;
detecting an existence of a key by the handheld electronic device;
establishing a wireless connection with the key by the handheld electronic device;
checking whether the handheld electronic device and the key are a credential pair by the handheld electronic device;
sending an instruction by the handheld electronic device to the key to search the vehicle when a result of the checking shows that the handheld electronic device and the key are a credential pair;
detecting an existence of the base station by the key;
establishing a wireless connection with the base station by the key;
checking whether the key and the base station are a credential pair by the key;
sending the instruction by the key to the base station to search the vehicle when a result of the checking shows that the key and the base station are a credential pair;
sending position information of the vehicle by the base station to the handheld electronic device via the key after the base station receives the instruction.

10. The method of claim 9, wherein the handheld electronic device has a display screen showing the position information of the vehicle thereon.

11. The method of claim 10, wherein the handheld electronic device is a mobile phone.

12. The method of claim 11, wherein the mobile phone is a smart phone.

13. The method of claim 10, wherein the handheld electronic device is a table computer.

14. The method of claim 10, wherein the key is a chip key programmed with one of RKE (remote keyless entry) system and PKE (passive keyless entry) system.

15. The method of claim 10, wherein the establishment of the wireless connection by the handheld electronic device with the key is achieved by a wifi wireless connection.

16. The method of claim 10, wherein the establishment of the wireless connection by the handheld electronic device with the key is achieved by a Bluetooth wireless connection.

17. The method of claim 10, wherein the establishment of the wireless connection by the key with the base station is achieved by an RF wireless connection.

18. A method for remotely controlling operation of a vehicle comprising:
executing an application in a handheld electronic device;
detecting an existence of a key by the handheld electronic device;
establishing a wireless connection between the handheld electronic device and the key;
checking whether the handheld electronic device and the key are a credential pair;
commanding the key to read and write an instruction from the handheld electronic device if the key and the handheld electronic device are a credential pair;
detecting an existence of a base station in the vehicle by the key;
establishing a wireless connection between the key and the base station;
checking whether the key and the base station are a credential pair;
commanding the base station to read and write the instruction from the key if the key and the base station are a credential pair; and
performing an action by the base station in accordance with the instruction.

19. The method of claim 18, wherein the action is to send position information of the vehicle to the handheld electronic device via the key.

20. The method of claim 18, wherein the action is to control an operation of the vehicle.

21. A system for identifying a position of a vehicle comprising:
a handheld electronic device;
a key in bi-directional wireless communication with the handheld electronic device, the key being configured for controlling operations of the vehicle;
a base station configured to be mounted in the vehicle, the base station being in bi-directional communication with the key;
wherein when the handheld electronic device sends out an instruction for searching the vehicle, the key receives the instruction and sends the instruction to the base station, the base station sends position signal to the handheld electrical device via the key after receiving the instruction whereby the handheld electrical device shows a position of the vehicle on a display screen of the handheld electronic device.

22. A system for identifying a position of a vehicle on a handheld electronic device, comprising:
a handheld electronic device configured to communicate with a vehicle key in a bi-directional wireless manner;
wherein, the vehicle key is able to communicate in a bi-directional wireless manner with a base station mountable in a vehicle;
wherein when the handheld electronic device sends search instructions to the vehicle key to search for the vehicle, the vehicle key sends the search instructions to the base station; and
wherein, when the base station receives the search instructions from the vehicle key, the base station sends a position signal to the vehicle key and the vehicle key forwards the position signal to the handheld electronic device allowing the handheld electronic device to display a position of the vehicle on a display screen of the handheld electronic device.
